(19) United States
(12) Patent Application Publication
(10) Pub. No.: US 2024/0246331 A1
(43) Pub. Date: Jul. 25, 2024

(54) LENS HOLDER, PROTECTIVE FILM REMOVAL DEVICE, AND METHOD FOR DETACHING A PROTECTIVE FILM FROM AN OPTICAL LENS

(71) Applicant: OptoTech AG, Zuchwil (CH)

(72) Inventors: Andreas BUCHER, Günsperg (CH); Olga ENGELMANN, Ostermundigen (CH); Daniel MEIER, Bützberg (CH); Claude VOLKEN, Balsthal (CH); Dietmar SCHMIDT, Waltrop (DE)

(21) Appl. No.: 18/414,643

(22) Filed: Jan. 17, 2024

(30) Foreign Application Priority Data
Jan. 20, 2023 (EP) 23 152 604.7

(51) Int. Cl. B32B 43/00

(52) U.S. Cl. CPC B32B 43/006

(57) ABSTRACT

A lens holder for accommodating an optical lens includes a carrier element that forms a receptacle area for the lens, a sealing structure or seal on the carrier element for fixing the lens in the receptacle area by negative pressure. A camera is arranged behind the receptacle area, using the image area of which a light distribution in the receptacle area is acquired. A protective film removal device is provided with the lens holder, wherein an action mechanism is designed to act mechanically, thermally, chemically, pneumatically, or hydraulically on a protective film on a lens. An evaluation device, linked to the camera, is designed to evaluate the light distribution in the receptacle area, which is dependent on the progress of the detachment of the protective film. A method and a use of the lens holder is also provided in terms of detaching a protective film from an optical lens.

The invention relates to a lens holder according to the preamble of claim 1, a protective film removal device for detaching a protective film from an optical lens having such a lens holder according to claim 6, a method for detaching a protective film from an optical lens according to claim 13, and the use of the lens holder according to claim 15.

Spectacle lenses, for example, are produced from optical lens blanks. Although individual optical surfaces have to be produced for this purpose, in order to be able to correct visual defects of persons, the manufacturing is equivalent to mass production. The spectacle lenses may only be produced cost-effectively in this way. Because the production of optics is classically manual work and a high level of flexibility is still required in order to produce the required optical surfaces, numerous machines exist in the prior art to carry out individual work steps in an automated manner, thus, for example, milling machines, turning machines, polishing machines, and coating machines. However, manual work steps are still carried out between these automated work steps.

One of these work steps relates to pulling off protective films which are applied to a second lens surface of an optical lens blanks so that the first lens surface can be processed without the second lens surface being damaged in this case. To pull off the protective film, a worker takes, for example, a pointed tool to lift up the protective film and then pull it off. However, this is time consuming and additionally results in scratches on the surface of the lens blanks. The discard rate is increased in this way.

Detaching a protective film from a lens surface by grasping this protective film in an area in which it spans a recess in the lens surface is known from DE 10 2015 121 682 A1. The protective film is then pulled off mechanically. This has the disadvantage that the recess has to be formed before the application of the protective film in order that it can be grasped later at all.

A method for removing a protective film from a lens is known from EP 2 042 265 B1, in which the lens is rotated while hot fluid is sprayed from the circumference against the lens using a single nozzle having variably inclined fluid jet (corresponding to a dirt blaster of a high-pressure cleaner). The protective film is heated by the conical hot pressurized jet, which changes with respect to the angle, and the adhesive of the protective film becomes soft. Finally, the adhesive of the protective film melts enough that the protective film detaches at its circumference assisted by the pressurized jet. The protective film then detaches successively further by assistance of the pressure of the fluid jet. It is disadvantageous in this case that the work process has to be designed as sufficiently long that it removes all protective films with very high probability. In all other cases with less stubborn protective films, the removals comprise an excess expenditure of work and resources. A further disadvantage is the residue of molten adhesive on the lens surface, which has to be removed afterward. In addition, a very large amount of hot fluid is required, which has a large surface in relation to the surroundings due to its conical spraying. A large amount of thermal energy is therefore lost to the surroundings, which accordingly has to be resupplied. In addition, a large amount of very humid air arises, which escapes into the factory halls.

A protective film removal device is described in EP 4 101 586 A1, in which a straight fluid jet is moved around the lens circumference using a fluid nozzle and wavy movements are carried out over the separation point between second lens surface and protective film. The problem is also confronted in this case that the removal process has to be designed for the worst possible case, from which long process times for all optical lenses result. Moreover, the more precisely the nozzle movements are designed, the more the access to the separation point can be lost along the nozzle path and the continuation of the nozzle movement no longer achieves progress from this error point. The work process then has to be started from the beginning and the path has to be travelled again completely using the fluid nozzle. Reference is hereby made in its entirety to EP 4 101 586 A1, the content of which is hereby incorporated in this application, wherein in particular all optional features of EP 4 101 586 A1 can also be optional subject matter of the present invention.

The object of the invention is to provide a solution using which a protective film may be removed efficiently, effectively, and as much as possible without adhesive residues from a lens surface. A high degree of automation is to be achieved and the solution is to be easily executable and cost effective.

The main features of the invention are specified in the characterizing part of claim 1, and claims 6, 13, and 15. Embodiments are the subject matter of claims 2 to 5, 7 to 12, and 14.

The invention relates to a lens holder for accommodating an optical lens, in particular an optical lens having a first lens surface, a second lens surface opposite to the first lens surface, and a lens circumference, having a carrier element which forms a receptacle area for the optical lens, and having a sealing structure or seal on the carrier element for fixing the optical lens in the receptacle area by negative pressure. It is provided here that a camera is arranged behind the receptacle area, using the image area of which a light distribution in the receptacle area is acquired.

This camera enables a removal process of the protective film to be observed and evaluated from the rear side of the optical lens. In particular, it may be checked whether the protective film (e.g., a foil, a tape, or also a sprayed-on film) was successfully removed. Discards and reworking are reduced and no disturbances, for example, of suction holders occur during the unloading of the optical lenses from the lens holder. Moreover, the point in time of the removal may be determined during the removal process and the process may be immediately ended individually. This increases the throughput, reduces the resource use, and lengthens maintenance intervals. Acting in a targeted manner on local protective film residues is also enabled, because the position thereof can be determined. In most cases, the optical lens has an optical effect and a sharp image will therefore only be present in very rare cases. Therefore, contours play more of a subordinate role in the evaluation. The focus of the evaluation is in the light distribution, for example, also including the light colour, which is influenced by the shading using the protective film. The shading changes with the progress of the protective film removal. The holding by negative pressure is particularly gentle for possibly already optically active surfaces.

In the optical lens, the first and second lens surface are typically delimited by the lens circumference. In addition, it has an (imaginary) optical axis around which the lens circumference extends. The optical lenses also include unprocessed and partially processed lens blanks and the individual manufacturing stages of spectacle lenses from a lens blank.

The lens holder is to have an imaginary centre axis which, in particular with accommodated optical lens, is aligned transversely to the first and second lens surface and preferably at least essentially coincides with the lens axis.

According to a more detailed design of the lens holder, the seal is a sealing ring and the camera is arranged set back in the centre of the sealing ring. The camera thus lies protected in the centre of the sealing ring. For example, sprayed water and mist cannot reach here, so that the evaluation of the light distribution can also take place while such interfering factors are present outside the seal.

In a special refinement, the camera is arranged fluid-tight in a housing of the lens holder. The camera is thus protected from moisture damage and the lens holder can be used and exchanged, for example, as a plug and play modular unit.

In one preferred embodiment, an optically transparent pane is seated in the housing between the camera and the receptacle area. This permits a camera which is not fluid tight as such to be used and helps to define its image area by way of the distance to the receptacle area. The largest possible area of the second lens surface may thus be acquired using the camera without special camera optics having to be used.

A cavity, into which a negative pressure channel opens, is optionally formed between the camera and the receptacle area. The cavity keeps the optical path free for the camera and enables a negative pressure to be generated to the suction holders of the optical lens behind the first lens surface. To the greatest extent possible, no component made of non-optically transparent material is thus located in particular in the centre of the sealing ring. The negative pressure channel can especially be connected to a negative pressure pump here. Therefore, rapid and automated suctioning of the optical lens firmly on the lens holder takes place. Alternatively, an openable check valve could also be arranged in the negative pressure channel, so that the lens is fixable on the sealing ring by pressing on (similarly to a suction cup), and detaches again after opening of the check valve. In particular, the seal is to be in contact with the first lens surface. The negative pressure channel is to open into the cavity at a geodetic low-lying point, ideally the lowest-lying point, in particular if the cavity is geodetically below the receptacle area. Any possible moisture and dirt may thus also be evacuated from the cavity upon the generation of the negative pressure, so that they do not form interfering factors in the image area of the camera.

The invention additionally relates to a protective film removal device having a lens holder as specified above and below. The lens holder is designed here to hold an optical lens having a first lens surface, a second lens surface opposite to the first lens surface, and a lens circumference, wherein the optical lens faces with the first lens surface in the direction of the lens holder and a protective film is applied to the second lens surface, in a removal station for detaching the protective film from the second lens surface of the optical lens. The removal station has an action means which is designed to act on the protective film mechanically (for example by grasping, pulling, or scraping), thermally (for example using infrared radiation, hot air, or warm fluid), chemically (for example using a solvent for dissolving the protective film or its adhesive), pneumatically (for example using compressed air), or hydraulically (for example using a fluid jet), in particular to remove it from the second lens surface. The removal station has an evaluation device which is linked to the camera and is designed to evaluate the light distribution in the receptacle area.

The light distribution enables a conclusion about where and when the protective film has been successfully removed, in particular before, after, and during the action on the protective film. The duration, intensity, and locality of the action may be reduced to the required extent.

Light parameters are preferably stored in the evaluation device, which differentiate between a presence or absence of a protective film on the second lens surface in the area of an image detail of the image area. This enables a comparison of actual parameters to expected light parameters.

The evaluation device is furthermore preferably designed to use the light distribution before the action as input parameters and to evaluate the following change of the light distribution. The individual situation with the just processed optical lens may be judged using these actual parameters and compared to expected light parameters.

There is the option of successively generating new data sets for the light parameters during the processing of the individual optical lenses and storing them as comparison values in the evaluation device.

It is optionally also possible that the evaluation device is designed to take into consideration the optical effect of the optical lens located in the lens holder and/or the type of the protective film as input parameters. The evaluation may thus be carried out on the basis of comparable data sets using light parameters, for example. In a thin optical lens having small curvature, for example, very little edge light penetrates via the lens circumference of the optical lens into the centre. In thick lenses, the edge area may appear sufficiently bright that one would hardly expect a protective film in this area. Knowledge about the type of the protective film provides information about whether full shading is to be expected or, for example, there is partial transparency. With a green or blue colour of the protective film, for example, with partial transparency, light wavelengths can be influenced upon the penetration of the protective film or upon reflection at film edges, which can be evaluated.

According to a more detailed embodiment of the protective film removal device, it has a light source which illuminates the receptacle area of the lens holder. A better-defined evaluation environment can thus be provided. For this purpose, the light source is preferably to emit light in the direction of the camera, so that in particular the optical lens is positioned between the light source and the camera. In an additional or alternative embodiment, the lens holder has an internal light source behind the receptacle area, so that the gap between receptacle area and camera is illuminated. Even if the surroundings are nearly completely dark due to the action on the protective film, colour differences/light wavelengths in the shading due to the protective film and the shading due to, for example, spray mist can thus still be concluded from the rear side of the optical lens. There is the option of activating the light sources individually, for example, alternately, and making individual evaluations. A further option is to activate the light sources using defined light wavelengths and to carry out individual evaluations according to the respective light wavelength used. Wavelengths not visible to the human eye are also usable in this case.

In a special embodiment, the light source is kinematically coupled to a closure element of a machine housing, and in particular takes a work position in a closed position of the closure element in which it illuminates the receptacle area of the lens holder, and the light source is moved out of the work position in an open position of the closure element. The action on the protective film can thus take place protected in the machine housing, and the closure element may be opened to load and unload the lens holder with optical lenses. The light source is advantageously moved directly to the side in this case in order to expose the access to the receptacle area of the lens holder. The light source can thus have its work position, for example, directly centrally in the centre axis of the lens holder.

Furthermore, an external camera can optionally be arranged outside the lens holder, which acquires the second lens surface from the direction opposite from the camera with its image area. The camera already introduced above has the advantage of a free view even during the action on the protective film, for example, in the event of sprayed water and mist. However, due to the optical effect of the optical lens and the image fuzziness resulting therefrom, object recognition can hardly be performed, rather it is necessary to work with the light distribution due to shading fields by the protective film. The advantage of the external camera is that it has a free view through the lens holder without field-of-view restrictions and the image sharpness is not impaired by an optical effect of the optical lens. In addition, image parameters such as colours and light refraction edges can be evaluated using the external camera at least before and after the action on the protective film. An additional check is enabled to ensure that the protective film is completely removed, for example, if the optical lens is also held using a sealing ring on the outer circumference of the optical lens, which can be concealed by the sealing ring for the camera.

The evaluation device can be linked to the external camera and can be designed to carry out object recognition in the receptacle area, in particular by evaluating indicators for a protective film or protective film residues on the second lens surface. Image parameters can be stored here in the evaluation device, which differentiate between a presence or absence of a protective film on the second lens surface in the area of an image detail of the external camera. These can be, for example, colours of the protective film and light edges of folded or partially detached protective films. New data sets can also be successively generated for these image parameters during the processing of the individual optical lenses and stored as comparison values in the evaluation device.

A further input parameter of the evaluation device in the evaluation can be the specific geometry of the optical lens. The knowledge of the position of, for example, the edge between lens circumference and second lens surface facilitates the comparison to other data sets.

The lens holder can especially have an imaginary centre axis, and the action means has at least one fluid nozzle having a nozzle outlet channel and at least one pivot mount between the lens holder (on one hand) and the fluid nozzle or nozzles (on the other hand), wherein the pivot mount is designed such that a relative movement around the centre axis is executable using the fluid nozzle or nozzles, wherein the nozzle outlet channel of the fluid nozzles is oriented inward in each case (in particular in relation to the pivot mount). In particular in these spraying methods, quite variable minimal action durations are necessary to detach the protective film, while so much spray mist arises at the same time that no observations of the work progress can be made from the outside. This is remedied using the camera according to the invention of the lens holder.

According to one embodiment variant, a lifting device is formed between the lens holder (on the one hand) and the fluid nozzle or nozzles (on the other hand) such that a relative movement in relation to the lens holder is executable using the fluid nozzle or nozzles, which is oriented longitudinally, preferably at least essentially parallel, and particularly preferably parallel to the centre axis. The advantage of the lifting device is that the fluid jet or jets of the fluid nozzles can be led around the circumference, on the one hand, and in addition can be adjusted with respect to their vertical position, and this can be done, for example, continuously, slowly, quickly, in an oscillating manner, jerkily, or harmonically. The fluid jet may thus not only be directed onto the lens circumference around the circumference, but rather may deliberately be adjusted to the vertical positions in which the best possible detachment effect is achieved for the protective film. This takes into consideration in particular the circumstance that the optional point of incidence of the fluid with the successively detaching protective film shifts. Precise, local detaching of the protective film is achieved by means of the lifting device. Instead of working with a large-volume fluid jet, it is sufficient to use a substantially finer fluid jet by way of the lifting device. Fluid and energy are saved in this way. The pivot mount and/or the lifting device can also be individually activated on the basis of current data by evaluating the light distribution in order to detach the protective film efficiently.

The lifting device can optionally have a lifting drive. The lifting movement is thus executable individually. The lifting drive is preferably a pneumatic lifting cylinder or an electric motor, for example, an electric linear motor or a spindle drive. A pneumatic lifting cylinder acts comparatively quickly, while very precise positioning movements and positioning movements having defined accelerations can be carried out using the electric motor. The target position may thus be aimed at particularly precisely. In addition, the optional oscillating movements can be executed using particularly small positioning paths. The position of the upper glass edge of the optical lens is preferably known for this purpose, thus the glass edge between second lens surface and lens circumference. The optional oscillation can thus be brought to a minimum along the glass edge, and maximum effectiveness of the fluid jet or the fluid jets may thus be achieved.

A more cost-effective alternative to the lifting drive would be a mechanical correlation gear, for example, a cam gear, which couples the lifting movements of the lifting device to the rotational movement of the pivot mount.

The lens holder is preferably arranged in a rotationally-fixed manner, in particular rotationally-fixed relative to a machine framework, and the fluid nozzle or the fluid nozzles are each arranged rotatably around the pivot mount, in particular rotatable relative to a or the machine framework. The lens holder is in particular to be designed to hold the optical lens in a rotationally-fixed and axially-fixed manner in the receptacle area. A kind of nozzle carousel results therefrom, using which the fluid nozzles are rotated around the lens holder. A steady image is generated using the camera, and changes of the light distribution due to rotating of the optical lens are not to be expected. This is because the lens surfaces are often not rotationally symmetrical in particular in the case of spectacle lenses.

In a different or additional embodiment of the invention, the nozzle outlet channel or channels are each designed such that they generate an at least essentially straight, in particular cylindrical and in particular laminar, jet of fluid. The use of such a jet enables the detachment of the protective film to be simulated and optimized with regard to the resources of fluid and energy used in a significantly simpler manner than with turbulent jets as with a dirt blaster. In contrast to such a jet having a changing inclination, the straight jet may be oriented finely on the separating line between the optical lens and the protective film. Ineffective frontal blasting of the lens circumference can be reduced at the same time. In variants having more than one fluid nozzle, the fluid jets of the fluid nozzles can optionally have the same or a differing diameter. Equal diameters are suitable in particular if the rotational angle is designed so that each fluid nozzle is responsible for detaching the protective film in a defined rotational angle range. At larger rotational angles, advantages are achievable using different diameters of the fluid jets, because multiple nozzles then process the same angular range of the optical lens and different diameters of the fluid jets are accompanied by different active forces on the protective film, which can mutually supplement one another.

According to a further optional embodiment of the invention, the nozzle outlet channel or channels are each supplied with fluid via a feed, in particular a common feed, wherein a conveyor pump, in particular a common conveyor pump, and/or a cooling device, in particular a common cooling device, for cooling the fluid is arranged in the feed. Using a common conveyor pump is cost-efficient. A cooling device has the advantage that even at unfavourable ambient temperatures, for example, in non-air-conditioned factory halls, undesired heating of the fluid can be prevented. In this way, it is additionally possible to prevent the adhesive of the protective film from melting and residues thereof from remaining on the lens surface. The cold fluid contributes to the adhesive adhering to the detaching protective film. The feed is optionally also to include the section from the exit from the fluid nozzles, in particular if a recirculation of the fluid for renewed use is provided. The cooling device can be designed as a passive heat exchanger. To be independent of ambient parameters, it is advisable as an alternative for the cooling device to have a cooling assembly or a heat pump. The waste heat of the fluid can optionally be utilized, for example, by a fan for blowing the lens dry after the protective film is detached.

In one particular embodiment, a collection container is arranged in the feed, in which fluid exiting from the fluid nozzles collects. The fluid may thus be used repeatedly in this way. A filter is preferably arranged in the feed. Dirt particles such as processing residues, which can adhere to the optical lens before the protective film is detached, can thus be removed from the fluid.

The nozzle outlet channel or channels can especially each have a static angle, in particular relative to the centre axis, with the exception of the pivot mount. The device thus manages with few drives, even if multiple fluid nozzles are provided. Preferably, the nozzle outlet channel points or the nozzle outlet channels point slightly diagonally from above in the direction of the lens holder and/or its receptacle area. Furthermore, the angle between an orientation plane, which is oriented perpendicularly to the centre axis, and the nozzle outlet channel or channels is preferably between −5° and 50°, more preferably between 0° and 40°, and particularly preferably between 5° and 35°.

According to an optional refinement, the pivot mount has a pivot bearing and a boom or a disk thereon, wherein the fluid nozzle or the fluid nozzles are each fixed on the boom or the disk. In this way, a small pivot bearing may be used in the centre and the fluid nozzles may nonetheless be arranged at a distance from the centre, for example, also in the form of a basket or cup, in the centre of which the lens holder can be placed.

A further additional or alternative embodiment of the invention can be that the pivot mount has a limited pivot range, wherein the pivot range is preferably less than 360°, and wherein preferably a pivot drive having a direction changer is provided, in particular to pivot the fluid nozzles and the lens holder or its optional receptacle surface back and forth relative to one another with a change of the pivot direction. A lesser load requirement is thus placed on the ability to pivot, which also includes in particular different pivot feedthroughs, via which, for example, the fluid can be transported to the fluid nozzles. With limited pivot angles, instead of pivot feedthroughs, the use of, for example, flexible hoses can also come into consideration.

In one particular embodiment, the lens holder is arranged fixed in the vertical position, in particular during the detachment of the protective film and in particular fixed in the vertical position relative to a machine framework, and the fluid nozzles are movably driven using the lifting device longitudinally in relation to the centre axis, in particular movably relative to the machine framework. The tools, namely the fluid nozzles, of the vertically-movable part, can thus be oriented on the workpiece, namely the optical lens. Optionally, however, the mounting can also be embodied in reverse.

One optional variant is that the pivot mount is arranged between the lifting device on the one hand and the fluid nozzle or nozzles on the other hand. The pivot mount is then also moved with the lifting device. Alternatively, the arrangement could also be reversed, thus the lifting device could be arranged between the pivot mount on the one hand and the fluid nozzles on the other hand. The lifting device is then part of the rotating mass.

The protective film removal device optionally has exactly two or at least two or exactly three or at least three fluid nozzles. Two, three, or more fluid nozzles contribute to fewer relative revolutions being necessary between the optical lens and the fluid nozzles to remove the protective film. The variants having exactly two or exactly three fluid nozzles are the preferred numbers here for reasons of cost.

According to a further additional or alternative embodiment of the invention, the protective film removal device has exactly two or at least two fluid nozzles, wherein one of the two fluid nozzles is arranged offset by a defined angle of rotation around the centre axis in relation to the other of the two fluid nozzles. The speed of detaching the protective film is thus increased. The angle of rotation can be, for example, between 10 and 180°, is preferably between 20 and 90°, and particularly preferably between 30 and 60°. Furthermore, it is possible with the aid of the two fluid nozzles arranged offset to be able to travel along 360° of the lens conference even with a pivot range of the pivot mount of less than 360°.

Optionally, the two or three fluid nozzles can be fixedly connected to one another, so that a pivot mount is formed between the lens holder on the one hand and the two fluid nozzles on the other hand such that a relative movement around the lens holder is executable using the two fluid nozzles, wherein the nozzle outlet channels are oriented inward. Accordingly, the multiple fluid nozzles can share the pivot mount, pivot drives, lifting devices, the feed, and the like. A synchronous operation of the multiple fluid nozzles is accordingly possible. This keeps the design simple and the costs low. In particular, the fluid nozzles can at least partially or completely share the feed, in this case in particular at least partially or completely the conveyor pump, the collecting container, and/or the cooling device. The fluid nozzles are optionally made at least essentially structurally identical.

The pivot mount preferably has an axis of rotation which is oriented coaxially to the centre axis of the lens holder. A constant distance of the fluid nozzles to circular lens circumferences is thus achieved, wherein this is the most widespread embodiment of lens blanks.

It appears practical if the pivot mount is arranged on the side of the lens holder which faces away from the receptacle area of the optical lens. In this way, there is free access for loading and unloading the lens holder. In one preferred embodiment, the pivot mount lies geodetically below the lens holder. In this way, the optical lenses may be easily inserted from above and states of the lens holder are noncritical in which no fixing is active (such as power failure, work interruption, transfer times during the loading and unloading of the lens holder, etc.). The protective film removal device preferably has a loading and unloading device, which is designed to introduce optical lenses into the receptacle area of the lens holder and remove them therefrom. The loading and unloading device preferably has a suction holder here, which is designed to fix the optical lens using negative pressure on the second lens surface.

The pivot mount preferably has a pivot drive. This allows an active drive so that the fluid jets may be applied in a precisely controlled manner over the circumference of the optical lens. The pivot drive preferably has an electric motor. One conceivable alternative to the pivot drive would be, for example, a pivot movement which results from the momentum of the fluid jets.

Furthermore, the nozzle outlet channels can each point in the direction of the centre axis. Therefore, they strike without angling in the circumferential direction on the lens circumference or the separating line between lens surface and protective film. This angle proves to be particularly effective for detaching the protective film.

In addition, the protective film removal device can have a fan for blowing the optical lens dry.

Furthermore, the protective film removal device can have a wiping device, which is designed in particular such that the first lens surface of the optical lens accommodated in the lens holder can be wiped off using a wiping tool.

One particular embodiment of the invention is that the protective film removal device has a second removal station for removal of a protective film from a lens surface of a second optical lens at the same time as the initially described removal station. The possible throughput of lenses to be processed thus doubles. In this case, the first and second removal station can share a loading and unloading device, the feed (in particular up to a distributor), the conveyor pump, the collecting container, the protective cabin, a control unit, and/or the cooling device.

The second removal station can optionally also have the optional features of the first-mentioned removal station. The second removal station can thus have a further lens holder according to the invention, in particular for accommodating the second optical lens. According to the above-described embodiments of the initially described (first) removal station, this embodiment can also be formed in the second removal station. The advantages correspond to those of the first removal station, wherein as mentioned numerous machine components can additionally be shared, which also includes the evaluation device. In particular, the second removal station can have one or more of the optional features of the first removal station. The respective advantages of the first removal station also result here accordingly. It is thus also implementable in particular that the second removal station is designed at least essentially having the same features or even structurally identical to the first removal station. To utilize individually long processing times to detach the protective film, it is advisable to use individual chambers and closure elements for the two removal stations. The loading and unloading can be carried out asynchronously in this way and the lens which is processed faster does not have to wait for the slower one.

The invention additionally relates to a method for detaching a protective film from an optical lens comprising the following steps:
a) accommodating an optical lens having a first lens surface, a second lens surface opposite to the first lens surface, and a lens circumference in a lens holder, wherein the optical lens faces with the first lens surface in the direction of the lens holder and a protective film is applied to the second lens surface;
b) acquiring a light distribution in an image area of a camera, which is arranged on the side of the first lens surface, and acquires the second lens surface through the first lens surface with the image area;
c) carrying out a mechanical, thermal, chemical, pneumatic, or hydraulic work step for detaching the protective film from the second lens surface;
d) evaluating changes in the light distribution in the image area of the camera during or after the performance of the work step to detach the protective film;
e) repeating or continuing steps c) and d) until a successful removal of the protective film can be concluded on the basis of the changes in the light distribution in the image area.

It is therefore ensured according to the method that the protective film is reliably removed. In addition, the resource usage for the work step for detaching the protective film may be reduced to the required amount and the throughput of optical lenses that can be processed increases.

Step e) can comprise the output of a control signal to release and remove the optical lens from the lens holder when a successful removal has been established.

Step e) can optionally also comprise an abort signal, in order to remove the optical lens from the lens holder and identify it as an optical lens to be rechecked (preferably in the lens information of a control unit, not physically on the optical lens).

Furthermore, the method can optionally be supplemented with object recognition by means of an external camera, wherein the external camera acquires the second lens surface from the outer side and identifies objects on the second lens surface which indicate a protective film or protective film residues thereof. It is advantageous herein that there is no concealment of the second lens surface by the lens holder and the image is sharp. The evaluation can be carried out by means of indicators for a protective film or protective film residues on the second lens surface. For this purpose, image parameters can be stored in an evaluation device which differentiate between a presence or absence of a protective film on the second lens surface in the area of an image detail of the external camera. These can be, for example, colours of the protective film and light edges of folded or partially detached protective films. The image parameters can be taken or derived from preceding lens processing actions. The object recognition preferably takes place at least after the work step of detaching the protective film.

Optionally, an image comparison is carried out before and after the work step of detaching the protective film.

Furthermore, carrying out the work step to detach the protective film after step c) can be performed using at least one fluid nozzle which directs a fluid jet on the unit made up of the optical lens and the protective film. This is efficient processing gentle to the optical lens, wherein the evaluation of changes in the light distribution can take place from the rear side of the optical lens in spite of the resulting spray mist.

Preferably, a height oriented parallel to the lens axis or the diameter of the fluid jets are each less than the maximum distance, and preferably than the minimum distance, between the first and second lens surface. Such a fine fluid jet contributes to precision, efficiency, and resource preservation. In simplified terms, the optical lens is then thicker than the fluid jet.

Preferably, the fluid jet or jets have a circular cross section. In addition, it is preferred to make the fluid jet or jets cylindrical and/or laminar, in particular by appropriate configuration of the fluid nozzles. A compact, high-energy jet may thus be directed precisely on the separating zone between protective film and optical lens.

Furthermore, the fluid jets are to have a constant orientation and a constant inclination with respect to the lens axis with the exception of the pivot movements of the fluid nozzles. Steep angles of attack of the fluid jet in the separating zone between optical lens and protective film are ineffective. Because the lens curvature is comparatively flat, the angle of incidence only changes slightly during the displacement of the separating line during the successive detachment of the protective film. It would additionally be possible to compensate for this minor angle change, but this is complex in terms of technical implementation.

Furthermore, a relative rotational movement of the fluid nozzle or the fluid nozzles around the lens circumference can optionally be carried out, and the relative rotational movement can be overlaid by a relative lifting movement of the fluid nozzle or the fluid nozzles oriented longitudinally in relation to a lens axis of the lens. The rotational movement and the lifting movement permit the fluid jet to be guided precisely into the separating zone between protective film and second lens surface and the protective film to be successively detached. The rotational movement and lifting movement may be individually selected and optionally also optimized using the evaluation device for the use of different protective films and lens sizes, so that it is possible to also change over at short notice between different movement profiles, thus, for example, using electronically stored movement profiles.

According to the method, the lifting movement can take place in an oscillating manner and the fluid jet or fluid jets can be guided in an oscillating manner over a separating line between protective film and the second lens surface, wherein in particular the separating line shifts continuously toward the lens axis due to the successive detachment of the protective film. In particular lifting off of the protective film and its successive separation from the first lens surface thus occurs, until the protective film is finally removed from the first lens surface. This is comparable to a scraper (made of fluid) which is pushed multiple times from the lens surface (i.e., lens circumference or lens surface) in the direction of the protective film. The lifting movement could be modulated, for example, like a sine wave. Due to the shifting separating line, the zero-point position of the lifting movement can follow the separating line here.

The rotational movement can comprise a rotational direction change and can pivot the fluid nozzle or the fluid nozzles back and forth between two end positions.

During the performance of the method, both the lens holder as is described above and below with its optional embodiments and the protective film removal device as is described above and below with its optional embodiments can be used. Vice versa, the method can be functionally implemented by the lens holder or the protective film removal device.

Finally, the invention relates to the use of a lens holder as described above and below in detaching a protective film from an optical lens, and in particular the camera for evaluating the light distribution in the receptacle area to judge the work progress during the detaching of the protective film.

Further features, details, and advantages of the invention result from the wording of the claims and from the following description of exemplary embodiments on the basis of the drawings. In the figures:

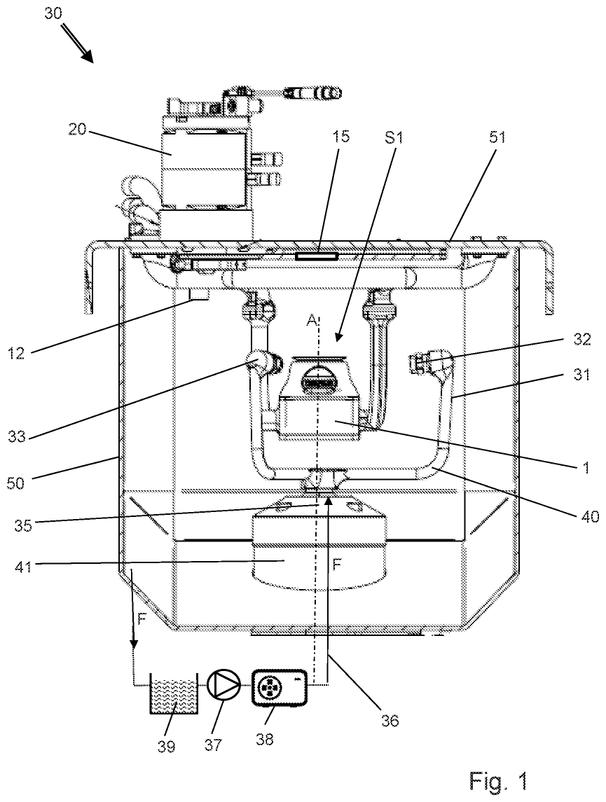

FIG. 1 shows a side view of a protective film removal device, wherein the machine housing is shown open through a vertical section;

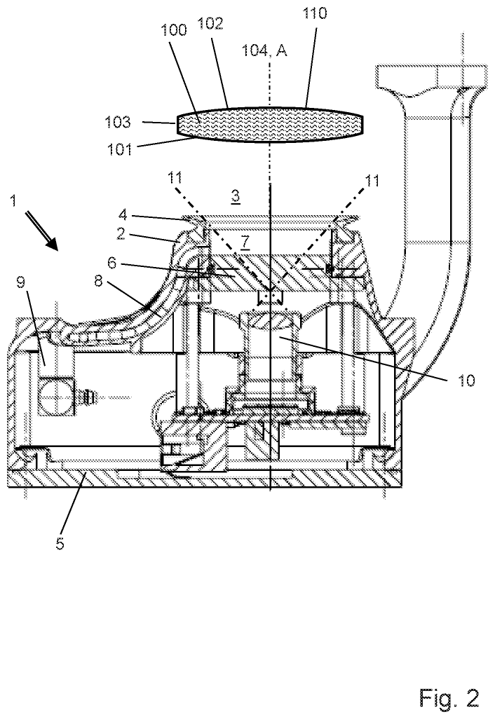

FIG. 2 shows a vertical section through a lens holder and an optical lens; and

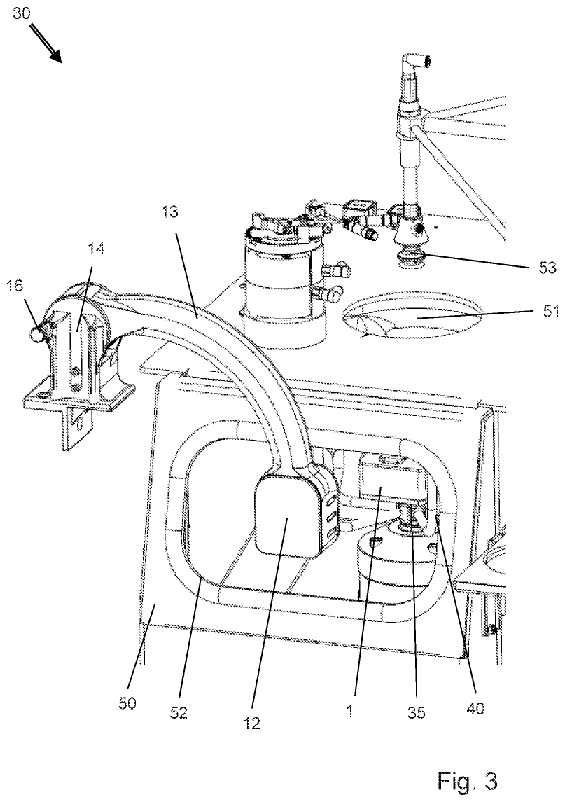

FIG. 3 shows a perspective view of a protective film removal device having external camera having holder.

FIG. 1 shows a section through a protective film removal device 30 having a first removal station S1 for detaching a protective film from a second lens surface of an optical lens of an unprocessed or partially processed lens blank (just optical lens hereinafter). A lens holder 1 is seated in the interior of a machine housing 50 of the protective film removal device 30. This will initially be described in more detail on the basis of FIG. 2.

FIG. 2 shows a vertical section through the lens holder 1 of FIG. 1 and through an optical lens 100. The optical lens 100 is shown axially spaced apart from the lens holder 1, as could be the case during loading or unloading of the lens holder 1. It has a first lens surface 101, which faces in the direction of the lens holder 1, a second lens surface 102, which is opposite to the first lens surface 101 and faces away from the lens holder 1, a lens circumference 103, which delimits the first and second lens surface 101, 102, and an imaginary lens axis 104, which intersects the first and second lens surface 101, 102 in their centre in each case. In most cases, this lens axis 104 also forms the centre axis for the lens circumference 103. A convex first lens surface 101 is shown. In particular in spectacle lens production, the first lens surface 101 is usually concave, however. A protective film 110, for example, a protective foil, is applied to the second lens surface 102.

The lens holder 1 designed to accommodate an optical lens 100 has a carrier element 2, which forms a receptacle area 3 for the optical lens 100. A seal 4, which is used to fix the optical lens 100 in the receptacle area 3 by way of negative pressure, is fastened on the carrier element 2.

The lens holder 1 has a camera 10 behind the receptacle area 3, wherein the camera 10 is arranged set back in the centre of the sealing ring 4. A light distribution in the receptacle area 3 is acquired using the image area 11 of the camera 10. The image angle of the image area 11 results due to the camera lens and extends up to the inside of the sealing ring 4. Due to the thickness of the optical lens 100, the second lens surface 102 can thus be acquired at least nearly completely.

The carrier element 2 is part of a housing 5, in which the camera 10 is arranged protected from fluid. An optically transmissive pane 6, preferably a transparent pane 6, is seated in the housing 5 here between the camera 10 and the receptacle area 3. If one only wishes to acquire defined light wavelengths, for example, to exclude ambient light influences, it is also possible to use a light filter pane.

A cavity 7, into which a negative pressure channel 8 opens at the geodetically lowest point, is formed between the camera 10 and the receptacle area 3, or between the pane 6 and the receptacle area 3. A negative pressure connection 9, for connecting a negative pressure pump seated outside the housing 5, is provided on the negative pressure channel 8. The negative pressure pump could also be seated directly in the housing 5 and can then be connected on the outlet side to the surroundings of the housing 5. As a further alternative, a controllable check valve could be inserted into the negative pressure channel 8 and the negative pressure could be generated by contact pressure on the optical lens 100.

As can be seen in FIG. 1, this lens holder 1 is suspended using two vertically oriented arms below the upper side in the machine housing 50. The arms are hollow and data and power lines lead through them into the interior of the housing 5 of the lens holder 1. The lens holder 1 is part of a removal station S1 for detaching the protective film 110 from the second lens surface 102 of the optical lens 100 and is designed to hold the optical lens 100 in this removal station S1.

The removal station S1 has an action means 31, which is designed to act mechanically, thermally, chemically, pneumatically, or hydraulically on the protective film 110. The lens holder 1 has an imaginary centre axis A, which coincides with the lens axis 104, and the action means 31 has three fluid nozzles 32, 33 (one of which is arranged concealed) each having a nozzle outlet channel. The fluid nozzles 31, 32 are arranged offset by defined angles of rotation around the centre axis A in relation to the other of the fluid nozzles 31, 32. In the case of three fluid nozzles 31, 32, an angle of rotation of 120° is advisable. The fluid nozzles 32, 33 are each arranged on a boom 40, which engages below the lens holder 1 like a cup, basket, or claw. A pivot mount 35 is formed between the lens holder 1 and the fluid nozzles 32, 33 or the boom 40 such that a pivot movement around the centre axis A is executable using the fluid nozzles 32, 33, wherein the nozzle outlet channel of the fluid nozzles 32, 33 is oriented inward in each case. In addition, a lifting device 41 is formed between the lens holder 1 and the fluid nozzles 32, 33 such that a lifting movement relative to the lens holder 1 is executable using the fluid nozzles 32, 33, which is oriented longitudinally in relation to the centre axis A. The lens holder 1 itself is secured in a rotationally-fixed and axially-fixed manner in the machine housing 50 and is accordingly designed to hold the optical lens 100 in a rotationally-fixed and axially-fixed manner in the receptacle area 3.

The nozzle outlet channels are each designed such that they generate an at least essentially straight and laminar fluid jet. For this purpose, the nozzle outlet channels are each supplied with fluid F via a feed 36, wherein a conveyor pump 37, a cooling device 38 for cooling the fluid F, and a collecting container 39 are arranged in the feed 36. The machine housing 50 drains into the collecting container 39.

In addition, the removal station S1 has an evaluation device 20, which is linked to the camera 10 and is designed to evaluate the light distribution in the receptacle area 3. Light parameters are stored in the evaluation device 20, which differentiate between a presence or absence of a protective film 110 on the second lens surface 102 in the area of an image detail of the image area 11.

To create a consistent evaluation environment, the protective film removal device 30 has a light source 15, which illuminates the receptacle area 3 of the lens holder 1. For this purpose, the light source 15 emits light in the direction of the camera 10. The light source 15 is kinematically coupled to a closure element 51 of the machine housing 50, in particular fastened thereon, so that in a closed position of the closure element 51 it assumes a work position in which it illuminates the receptacle area 3 of the lens holder 1, and it is moved out of the work position in an open position of the closure element 51. In this way, the light source 15 does not obstruct the loading and unloading of the lens holder 1 and separate drives are also not required for the light source 15.

In addition, an external camera 12 is arranged outside the lens holder 1 and using its image area it acquires the second lens surface 102 from the direction opposite to the camera 10. Different camera positions are possible here, for example, one that is more lateral, above all to identify resulting foil residues on the second lens surface 102, one centrally from above, for example in the centre of the light source 15, or—as shown—diagonally from above.

The evaluation device 20 is also linked to this external camera 12 and is designed to carry out object identification in the receptacle area 3, in particular by evaluating indicators for a protective film 110 or protective film residues on the second lens surface 102. Image parameters are stored for this purpose in the evaluation device 20, which differentiate between a presence or absence of a protective film 110 on the second lens surface 102 in the area of an image detail of the external camera 12.

FIG. 3 shows a perspective view of a protective film removal device 30 having external camera 12 and holding arm 13. The holding arm 13 holds the external camera 12 in front of a viewing window 52 of a machine housing 50, as is also described for FIG. 1. The lens holder 1 and the boom 40 of the fluid nozzles, and the pivot mount 35 thereof, can be seen through the viewing window 52. Reference is made in this regard to the description of FIG. 1. FIGS. 1 and 3 differ from one another with respect to the positioning of the external camera 12. The holding arm 13 is pivotable upward around a pivot axis 14 in order to expose the view through the viewing window 52 for a worker if needed. The holding arm 13 may be fixed in multiple pivot angles using a locking knob 16 in this case. Moreover, a loading and unloading device having a suction holder 53 for loading and unloading the lens holder 1 with optical lenses can be seen above the machine housing 50, namely through an opening in the machine housing 50 which is closed using a closure element 51 (optionally embodied as transparent here). To load and unload the lens holder 1, the closure element 51 is automatically moved from the closed position into an open position.

The invention is not restricted to one of the above-described embodiments, but is modifiable in a variety of ways.

All features and advantages disclosed in the claims, the description, and the drawings, including design details, spatial arrangements, and method steps, can be essential to the invention both as such and in greatly varying combinations.

List of reference signs

| | |
|---|---|
| 1 | lens holder |
| 2 | carrier element |
| 3 | receptacle area |
| 4 | seal |
| 5 | housing |
| 6 | pane |
| 7 | cavity |
| 8 | negative pressure channel |
| 9 | negative pressure connection |
| 10 | camera |
| 11 | image area |
| 12 | external camera |
| 13 | holding arm |
| 14 | pivot axis |
| 15 | light source |
| 16 | locking knob |
| 20 | evaluation device |
| 30 | protective film removal device |
| 31 | action means |
| 32 | fluid nozzle |
| 33 | fluid nozzle |
| 35 | pivot mount |
| 36 | feed |
| 37 | conveyor pump |
| 38 | cooling device |
| 39 | collecting container |
| 40 | boom |
| 41 | lifting device |
| 50 | machine housing |
| 51 | closure element |
| 52 | viewing window |
| 53 | suction holder (loading and |
| | unloading device) |
| 100 | optical lens |
| 101 | first lens surface |
| 102 | second lens surface |
| 103 | lens circumference |
| 104 | lens axis |
| 110 | protective film |
| A | centre axis (lens holder) |
| F | fluid |
| S1 | removal station |

1. Lens holder (1) for accommodating an optical lens (100), comprising a carrier element (2) that forms a receptacle area (3) for the optical lens (100), and comprising a sealing structure or seal (4) on the carrier element (2) for fixing the optical lens (100) in the receptacle area (3) by negative pressure, characterized in that a camera (10) is arranged behind the receptacle area (3), using the image area (11) of which a light distribution in the receptacle area (3) is acquired.

2. Lens holder (1) according to claim 1, characterized in that the seal (4) is a sealing ring and the camera (10) is arranged set back in the centre of the sealing ring.

3. Lens holder (1) according to claim 1, characterized in that the camera (10) is arranged fluid-tight in a housing (5) of the lens holder (1).

4. Lens holder (1) according to claim 3, characterized in that an optically transmissive pane (6) is seated in the housing (5) between the camera (10) and the receptacle area (3).

5. Lens holder (1) according to claim 1, characterized in that a cavity (7), into which a negative pressure channel (8) opens, is formed between the camera (10) and the receptacle area (3).

6. Protective film removal device (30) comprising a lens holder (1) according to claim 1,
wherein the lens holder (1) is designed to hold an optical lens (100) having a first lens surface (101), a second lens surface (102) opposite to the first lens surface (101), and a lens circumference (103), wherein the optical lens (100) faces with the first lens surface (101) in the direction of the lens holder (1) and a protective film (110) is applied to the second lens surface (102), in a removal station (S1) for detaching the protective film (110) from the second lens surface (102) of the optical lens (100),
wherein the removal station (S1) has an action means (31), which is designed to act mechanically, thermally, chemically, pneumatically, or hydraulically on the protective film (110), and
wherein the removal station (S1) has an evaluation device (20), which is linked to the camera (10) and is designed to evaluate the light distribution in the receptacle area (3).

7. Protective film removal device (30) according to claim 6, characterized in that it has a light source (15) which illuminates the receptacle area (3) of the lens holder (1).

8. Protective film removal device (30) according to claim 7, characterized in that the light source (15) is kinematically coupled to a closure element (51) of a machine housing (50), and in particular assumes a work position in a closed position of the closure element (51), in which it illuminates the receptacle area (3) of the lens holder (1), and is moved out of the work position in an open position of the closure element (51).

9. Protective film removal device (30) according to claim 6, characterized in that an external camera (12) is arranged outside the lens holder (1) and acquires the second lens surface (102) from the direction opposite to the camera (10) using its image area.

10. Protective film removal device (30) according to claim 6, characterized in that the lens holder (1) has an imaginary centre axis (A), and the action means (31) has at least one fluid nozzle (32, 33) having a nozzle outlet channel, and at least one pivot mount (35) between the lens holder (1) and the fluid nozzle or nozzles (32, 33), wherein the pivot mount (35) is designed such that a relative movement around the centre axis (A) is executable using the fluid nozzle or nozzles (32, 33), wherein the nozzle outlet channel of the fluid nozzles (32, 33) is oriented inward in each case.

11. Protective film removal device (30) according to claim 10, characterized in that a lifting device (41) is formed between the lens holder (1) and the fluid nozzle or nozzles (32, 33) such that a relative movement in relation to the lens holder (1), which is oriented longitudinally in relation to the centre axis (A), is executable using the fluid nozzle or nozzles (32, 33).

12. Protective film removal device (30) according to claim 10, characterized in that the lens holder (1) is arranged in a rotationally-fixed manner and the fluid nozzle or the fluid nozzles (32, 33) are each arranged rotatably around the pivot mount (35).

13. Method for detaching a protective film (110) from an optical lens (100) comprising the following steps:
a) accommodating an optical lens (100) having a first lens surface (101), a second lens surface (102) opposite to the first lens surface (101), and a lens circumference (103) in a lens holder (1), wherein the optical lens (100) faces with the first lens surface (101) in the direction of the lens holder (1) and a protective film (110) is applied to the second lens surface (102);
b) acquiring a light distribution in an image area (11) of a camera (10), which is arranged on the side of the first lens surface (101), and acquires the second lens surface (102) through the first lens surface (101) using the image area (11);
c) carrying out a mechanical, thermal, chemical, pneumatic, or hydraulic work step to detach the protective film (110) from the second lens surface (102);
d) evaluating changes in the light distribution in the image area (11) of the camera (10) during or after the performance of the work step to detach the protective film (110);
e) repeating or continuing steps c) and d) until a successful removal of the protective film (110) can be concluded on the basis of the changes in the light distribution in the image area (11).

14. Method according to claim 13, wherein an object identification is carried out by means of an external camera (12), wherein the external camera (12) acquires the second lens surface (102) from the outer side and identifies objects on the second lens surface (102), which indicate a protective film (110) or protective film residues thereof.

15. Use of a lens holder (1) according to claim 1 in detaching a protective film (110) from an optical lens (100), and in particular the camera (10) for evaluating the light distribution in the receptacle area (3) to judge the work progress when detaching the protective film (110).
